(19) United States
(12) Patent Application Publication
(10) Pub. No.: US 2012/0061229 A1
(43) Pub. Date: Mar. 15, 2012

(54) APPARATUS FOR SEPARATION AND CONDENSATION OF MIXTURE

(75) Inventors: Sung Chan Park, Gyunggi-do (KR); Ji Eun Joen, Seoul (KR); Kyoung Soon Park, Gyunggi-do (KR); Suk Jin Ham, Seoul (KR)

(73) Assignee: SAMSUNG ELECTRO-MECHANICS CO., LTD., Gyunggi-do (KR)

(21) Appl. No.: 12/984,782

(22) Filed: Jan. 5, 2011

(30) Foreign Application Priority Data
Sep. 15, 2010 (KR) 1020100090691

(51) Int. Cl. B01D 3/14

(52) U.S. Cl. 202/266

(57) ABSTRACT

Disclosed herein is an apparatus for separation and condensation of a mixture. The apparatus for separation and condensation of a mixture includes: a base part: a sample vaporizing unit mounted on the base part, and vaporizing the stored sample; a collecting unit mounted on the base part, in order to collect the sample; a driver moving the collecting unit pass; and a control device controlling the sample vaporizing unit to vaporize the sample and controlling the driver to move the collecting unit, whereby a small amount of mixture can be separated automatically.

### CROSS REFERENCE TO RELATED APPLICATION

This application claims the benefit of Korean Patent Application No. 10-2010-0090691, filed on Sep. 15, 2010, entitled “Apparatus for Separation and Condensation of Mixture,” which is hereby incorporated by reference in its entirety into this application.

### BACKGROUND OF THE INVENTION

1. Technical Field

The present invention relates to an apparatus for separation and condensation of a mixture.

2. Description of the Related Art

Revealing constituents of a mixture is a very important work industrially or scientifically. As a method of precisely analyzing constituents of a complex mixture, a separation analysis method based on a chromatography method has been most widely used up to now. However, an accumulated experience and a skilled technique are needed to perform the separation analysis using the method.

As another method for separation of a mixture, there is a fractional distillation method using a difference between boiling points of constituents. The typical fractional distillation apparatus associated with the method has been widely used for separation and purification such as petroleum refining.

However, the typical fractional distillation apparatus is too cumbersome to be used in chemical analysis and separation in coupling with a modern chemical analysis instrument. Further, the fractional distillation apparatus is appropriately designed for separation of a large amount of materials, it is not appropriate for separation and analysis of a small amount of sample.

As the existing technologies for separation and analysis of constituents using a difference between boiling points or evaporation points of materials, there is a fusion analysis technology such as TG-MS, TG-IR, which combine thermogravimetry with mass spectrometry and infrared spectroscopy, respectively.

These analysis methods measure a change in weight involved in evaporation, vaporization, and pyrolysis processes on a sample and at the same time, guide gas evolved and desorbed during each process to a mass spectrometer and an infrared spectrometer to analyze these gas components.

These analysis methods can perform the separation and analysis on line and sequentially, but analyze the gas flowing trensiently. As a result, these analysis methods are not appropriate to analyze the separated sample (gas) from various aspects a using several analysis methods.

Further, there is a need to extensively change the existing instrument in order to connect the separately manufactured thermogravimetric analyzer, mass spectrometer, and infrared spectrometer.

### SUMMARY OF THE INVENTION

The present invention has been made in an effort to provide an automatic apparatus for separation and condensation of a small amount of mixture including a sample vaporizing unit appropriate for vaporizing a small amount of sample and a collecting unit appropriate for collecting a small amount of sample.

An apparatus for separation and condensation of a mixture according to a preferred embodiment of the present invention includes: a base part: a sample vaporizing unit mounted on the base part, storing a sample, and vaporizing the stored sample; a collecting unit mounted on the base part, including a plurality of collectors formed to be consecutively arranged in a line in order to collect the sample, and allowing the plurality of collectors to sequentially pass through a gas evaporating from the sample vaporizing unit; a driver moving the collecting unit to allow the collectors of the collecting unit to sequentially pass through the sample vaporizing unit; and a control device controlling the sample vaporizing unit to vaporize the sample and controlling the driver to move the collecting unit.

The apparatus for separation and condensation of a mixture may further include a cooling unit cooling the collecting unit.

The apparatus for separation and condensation of a mixture may further include purging unit maintaining the collecting unit at a dried state.

The apparatus for separation and condensation of a mixture may further include a temperature measuring unit measuring a temperature of the sample vaporizing unit.

The control device may control a moving rate of the collecting unit in proportion to variation of temperature of the sample vaporizing unit.

The sample vaporizing unit may include: a sample cell storing the sample; a heater heating the sample cell; and a cell holder mounted on the base part and having the sample cell and the heater mounted therein.

The collecting unit may include: a moving plate including the plurality of collectors formed to be consecutively arranged in a line in order to collect the sample and moving to allow the plurality of collectors to sequentially pass through a gas evaporating from the sample vaporizing unit; and a supporting member supporting the moving plate to be spaced apart from the base part.

The apparatus for separation and condensation of a mixture may further include a guiding member formed with an opening that limits the evaporating gas to be condensed to only the defined collector.

The interval of the opening of the guiding member may be controlled.

The collector may have a plate shape.

The collector may be a solid plate having a micro pattern of an interval of 0.1 to 100 μm.

The collector may be a capillary array in which a capillary is formed in a lattice form.

The control device may include: a temperature controller increasing the temperature of the sample vaporizing unit in proportion to the set-up raising-temperature rate; a driving controller controlling the driver to move the collecting unit at the moving rate in proportion to the variation of temperature of the sample vaporizing unit; and a central controller controlling the driver through the driving controller in order to allow the moving rate of the collecting unit to be proportion to the variation of temperature of the sample vaporizing unit.

### BRIEF DESCRIPTION OF THE DRAWINGS

FIG. 1 is a perspective view of an apparatus for separation and condensation of a mixture according to a first preferred embodiment of the present invention;

FIG. 2 is a cutaway cross-sectional view of an apparatus for separation and condensation of a mixture of FIG. 1;

FIG. 3 is a plan view of a moving plate of FIG. 1;

FIGS. 4 to 8 are diagrams showing various preferred embodiments of a collector of FIG. 8;

FIG. 9 is a configuration diagram of a control device of FIG. 1;

FIG. 10 is a graph showing temperature over time and a moving rate of a moving plate;

FIG. 11 is a graph showing temperature over time and a collector number according to the temperature;

FIG. 12 is a perspective view of an apparatus for separation and condensation of a mixture according to a second preferred embodiment of the present invention;

FIG. 13 is a cutaway cross-sectional view of an apparatus for separation and condensation of a mixture of FIG. 12; and

FIG. 14 is a plan view of a moving plate of FIG. 12;

### DESCRIPTION OF THE PREFERRED EMBODIMENTS

Various objects, advantages and features of the invention will become apparent from the following description of embodiments with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc., can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

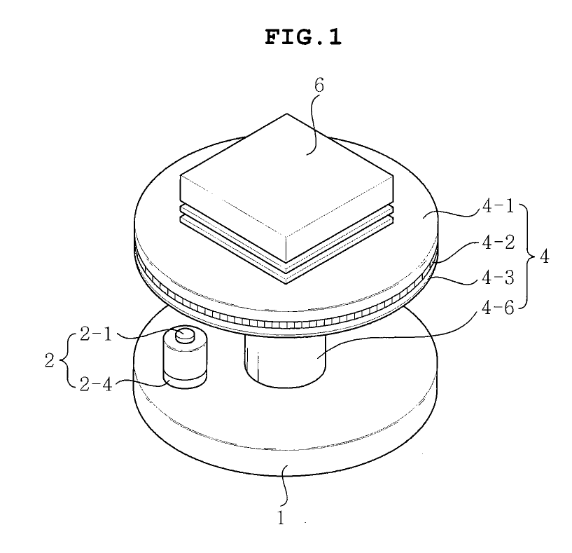

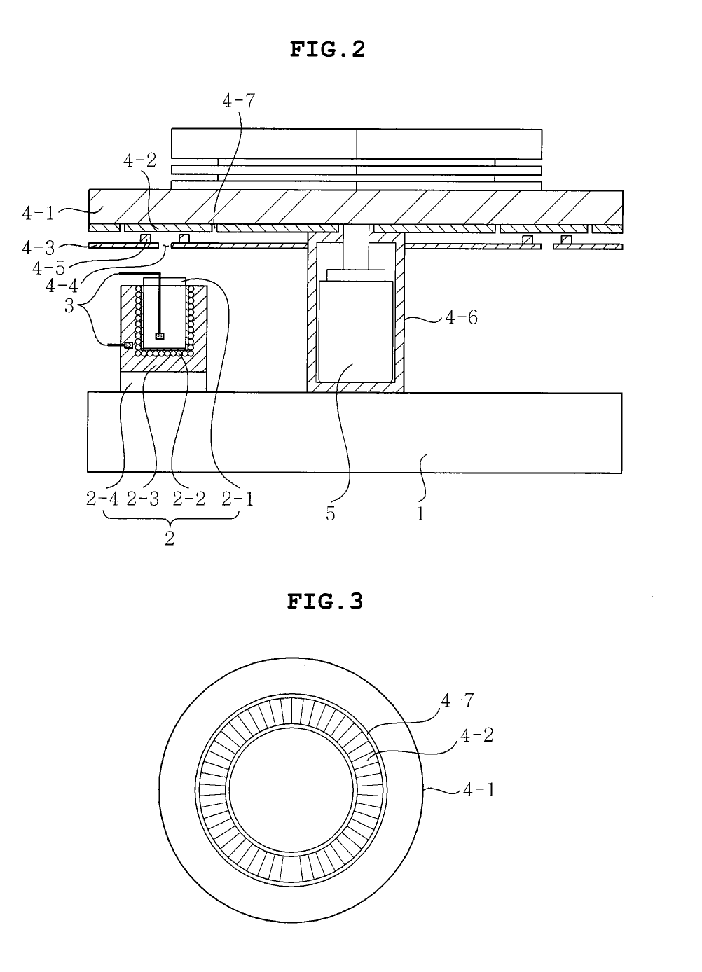

FIG. 1 is a perspective view of an apparatus for separation and condensation of a mixture according to a first preferred embodiment of the present invention, FIG. 2 is a cutaway cross-sectional view of FIG. 1, and FIG. 3 is a plan view of a moving plate of FIG. 1.

Referring to FIG. 1, an apparatus for separation and condensation of a mixture according to a first preferred embodiment of the present invention includes a base part 1, a sample vaporizing unit 2, a temperature measuring unit 3, a collecting unit 4, a driver 5, and a cooling unit 6.

In this configuration, the base part 1 is formed in a plate shape and is provided with the sample vaporizing unit 2, the driver 5, etc. In the FIG. 1, the base part 1 is formed in a circular plate, but is not limited thereto.

The sample vaporizing unit 2 is an apparatus that stores a sample and heats and vaporizes the stored sample. The sample vaporizing unit 2 includes a sample cell 2-1 including a sample, a heater 2-2 heating the sample cell 2-1, a cell holder 2-3 mounting the sample cell 2-1 and the heater 2-2, and a fixing member 2-4 fixing the cell holder 2-3 to the base part 1.

The sample stored in the sample cell 2-1 of the sample vaporizing unit 2 may be various liquid mixtures, a mixture of liquid and solid, or a solid mixture, or a solid of which surface and inside has foreign materials.

The sample cell 2-1 of the sample vaporizing unit 2, which has a cylindrical shape of which one surface has an opening, may have a structure appropriate for storing the sample and may use a material capable of transferring heat of the heater 2-2 to the sample well. In the cell holder 2-3 of the sample cell 2-1, a portion where the opening is formed may be partially protruded.

Next, the heater 2-2 of the sample vaporizing unit 2, which heats the sample cell 2-1, uses a thermoelectric element that is formed to surround the circumference of the sample cell 2-1 to uniformly heat the entire sample cell 2-1. Of course, the heater 2-2 of the sample vaporizing unit 2 may use an oven, etc., that can heat the entire sample cell 2-1.

The cell holder 2-3 of the sample vaporizing unit 2, which is used to mount the sample cell 2-1 and the heater 2-2, has a cavity appropriately formed to receive the sample cell 2-1 and the heater 2-2 therein, thereby making it possible to mount the sample cell 2-1 and the heater 2-2.

The shape of the cell holder 2-3 is shown in a cylindrical shape, but is not limited thereto. Therefore, the shape of the cell holder 2-3 can be implemented in various shapes.

In order to attach the cell holder 2-3 to the base part 1, the fixing member 2-4 is used, wherein a double-sided adhesive may be used as the fixing member 2-4. Differently from this, a fastening pin vertically protruded from the base part 1 may be used as the fixing member 2-4 in order to fix the cell holder 2-3 to the base part 1.

Meanwhile, the temperature measuring unit 3 is provided inside or around the sample cell 2-1 of the sample vaporizing unit 2, wherein the temperature measuring unit 3 measures temperature inside or around the sample cell 2-1 and transmits it.

In this case, as the temperature measuring unit 3, various kinds such as a platinum resistance temperature sensor, a thermocouple, a pyrometer, an IC thermometer, etc., may be used without being limited.

Next, the collecting unit 4 includes a moving plate 4-1, a plurality of collectors 4-2 formed to be consecutively arranged on one surface of a moving plate 4-1 in a line and to condense an evaporating gas thereto, a guiding member 4-3 provided with an opening 4-4 limiting the evaporating gas to be condensed onto only a defined collector 4-2, and a supporting member 4-6 installed in the base part 1 and supporting the moving plate 4-1 to be spaced apart from the base part 1.

In the configuration of the collecting unit 4, the moving plate 4-1 may be formed in a disk shape and may be rotated based on a shaft. Of course, the moving plate 4-1 is formed in a rectangular plate, such that it may be formed to perform a linear motion in a long side direction.

The material of the moving plate 4-1 may be made of various metals or polymer materials but is preferably copper having high thermal conductivity, which can be easily cooled by the cooling unit 6.

Grooves 4-7 in a track shape are formed around the center of the moving plate 4-1 as shown in FIG. 3 that is a plan view and the plurality of collectors 4-2 are consecutively attached to the grooves 4-7 in a line.

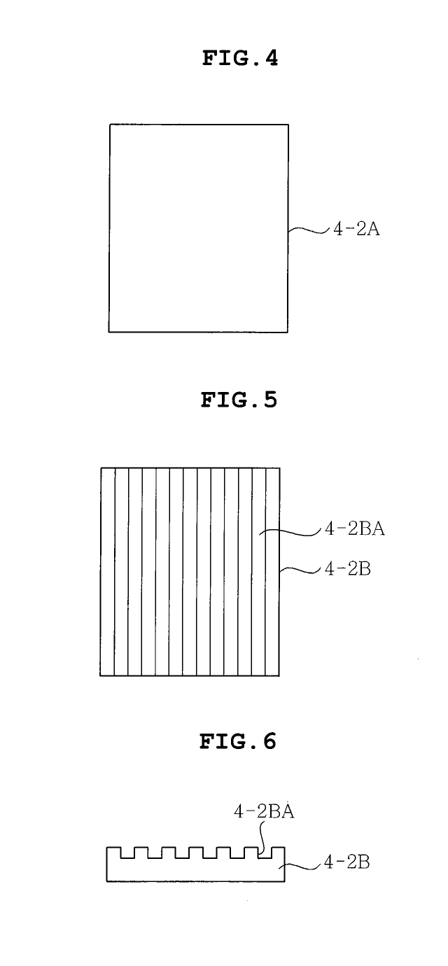

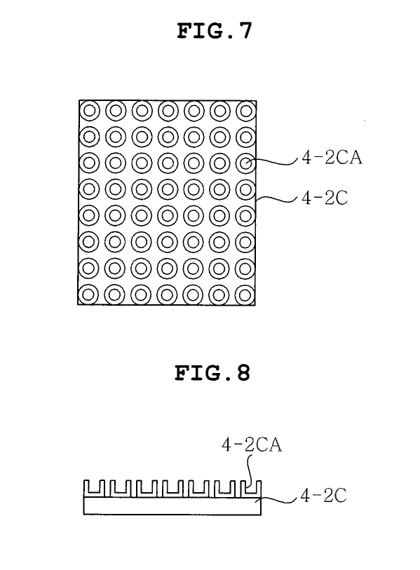

As the collector 4-2 attached to the moving plate 4-1, a smooth solid plate 4-2A such as a glass plate, etc., as shown in FIG. 4 may be used by way of example, a solid plate 4-2B having a micro pattern 4-2BA of an interval of 0.1 to 100 μm in order to increase collection efficiency using a capillary phenomenon as shown in FIG. 5 and as shown by a cross-sectional view in FIG. 6 may be used, or a capillary array 4-2C, in which a short capillary 4-2CA is densely formed in a lattice form, as shown in FIG. 7 and as shown by a cross-sectional view of FIG. 8, etc., may be used.

The material of the collector 4-2 may be metal, glass, semiconductor, and ceramic.

Next, the guiding member 4-3 may be formed in a plate shape including an opening 4-4 in order to guide the evaporating gas to a limited area of the collector 4-2, such that the evaporating gas may be condensed onto a specific one of the collectors 4-2 well

In the guiding member 4-3, the opening 4-4 may be formed in a funnel shape having a smaller diameter toward the collector 4-2.

In addition, the guiding member 4-3 further includes a spacing member 4-5 between it and the collector 4-2 so that it may be formed to be spaced apart from the collector 4-2 and controls the height of the spacing member 4-5, thereby making it to increase or reduce the spaced distance.

In addition, the size of the opening 4-4 of the guiding member 4-3 may be increased or reduced if necessary. As such, when controlling the size of the opening 4-4 formed in the guiding member 4-3 or the spaced distance from the collector 4-2, the amount of condensed gas and the separation resolution may be easily controlled.

Next, the supporting member 4-6, which supports the moving plate 4-1 to be spaced apart from the base part 1, may be formed in a hollow shape. The driver 5 is mounted in the supporting member 4-6. In this configuration, the supporting member 4-6 is formed to mount the driver 5 while supporting the moving plate 4-1. However, the driver 5 may instead serve as the supporting member 4-6 by supporting the moving plate 4-1 without including the supporting member 4-6.

Meanwhile, as the driver 5 moving the moving plate 4-1, a piezoelectric motor, a stepping motor, etc., may be used. When the moving plate 4-1 is rotatably configured in a disk shape, the driver 5 rotates the moving plate 4-1.

As the cooling unit 6 cooling the collector 4-2 in order to condense the evaporating gas onto the collector 4-2, a heat exchanger, a peltier cooler, etc., which may be connected to a refrigerant circulation apparatus, may be used.

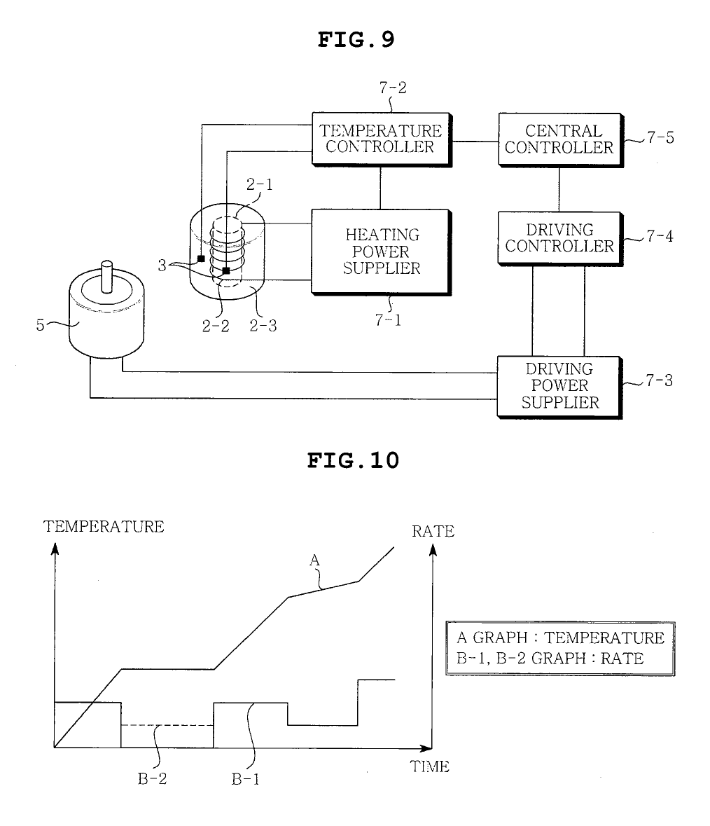

The apparatus for automatically separating and condensing a mixture according to the first preferred embodiment is driven and controlled by a control device. FIG. 9 shows a detailed configuration of the control device.

Referring to FIG. 9, a control device 7 used in the present invention include a heating power supplier 7-1, a temperature controller 7-2, a driving power supplier 7-3, a driving controller 7-4, and a central controller 7-5.

The heating power supplier 7-1 is an apparatus that supplies power to the heater 2-2. The temperature controller 7-2 appropriately controls power supplied to the heater 2-2 to maintain the temperature of the sample cell 2-1 to a desired temperature.

The driving power supplier 7-3 supplies power to the driver 5, such that the driver 5 can move the moving plate.

The driving controller 7-4 controls the driving power supplier 7-3 to control power supplied to the driver 5, thereby controlling the moving rate of the moving plate moved by the driver 5.

Next, the central controller 7-5 refers to the temperature measured by the temperature measuring unit 3 to control the moving rate of the moving plate moved by the driver 5 in proportion to the temperature.

Describing this with reference to FIG. 10 showing the rotational rate of the moving plate according to the temperature, when the temperature increases (referring to A graph), the moving rate of the moving plate is in proportion to the temperature gradient, while the moving rate of the moving plate is 0 (referring to B-1 graph) in the section where the temperature is not changed or maintain a predetermined rate as represented by a dotted line (referring to B-2 graph).

In this case, as can be appreciated from FIG. 11 showing the number of collector that remains to be exposed to the opening 4-4 of the guiding member 4-3 according to the temperature, a gas is condensed onto the corresponding collector (collector number 3) in a section in which the temperature of the sample cell is not changed.

The operation of the apparatus for separation and condensation of a mixture according to the first preferred embodiment of the present invention will be described.

First, after the sample is prepared and put in the sample cell 2-1 attached with the heater 2-2, the sample cell 2-1 is mounted in the cell holder 2-3.

The temperature inside and around the sample cell 2-1 is measured using the temperature measuring unit 3 around the sample cell 2-1.

As such, when the temperature of the sample cell 2-1 is determined, a pre-set temperature ramping rate Vₛ and a final temperature T_{f} are input to a central controller 7-5. In this case, the pre-set temperature ramping rate implies variation of temperature of the cell holder per unit time. The final temperature implies the highest heating temperature that can be reached. The pre-set temperature ramping rate and the final temperature may be directly input to the temperature controller 7-2.

In addition, a proportional constant z for controlling the rate of the moving plate is input to the central controller 7-5. Of course, the proportional constant for controlling the rate of the moving plate may be directly input to the driving controller 7-4 without passing through the central controller 7-5.

In this case, when the proportional constant is input to the central controller 7-5, the central controller 7-5 can control the driving controller 7-4 to allow the driver 5 to move the moving plate at the moving rate that is proportional to the actually measured ramping rate Vᵣ with the proportional constant

In other words, the central controller 7-5 may control the moving plate at a moving rate represented by the following Equation 1.

Vₘ=Z*Vᵣ [Equation 1]

Where Vₘ represents the moving rate of the moving plate, z represents the proportional constant, and Vᵣ is the actually measured temperature ramping rate.

Herein, the actually measured ramping rate implies variation per unit time of the temperature measured in the temperature measuring unit 3.

As such, when pre-set temperature ramping rate, the final rate, and the proportional constant for controlling the rate of the moving plate, etc., are input to the central controller 7-5, the temperature controller 7-2, or the driving controller 7-4, the central controller 7-5 or the temperature controller 7-2 controls the heating power supplier 7-1 to supply power to the heater 2-2, thereby heating the sample cell 2-1 in order to increase the temperature of the sample cell 2-1 in accordance with pre-set temperature ramping rate.

At the same time, when the temperature of the sample cell is measured by the temperature measuring unit 3 and is transferred to the central controller 7-5, the central controller 7-5 controls the driving controller 7-4 to rotate the moving plate at a rate in proportion to the actually measured temperature ramping rate of the sample cell with the proportional constant, such that the driving power supplier 7-3 appropriately supplies power to the driver 5.

By the above-mentioned process, the moving plate rotates at a rate in proportion to the actually measured temperature ramping rate and collects the gas evaporating from the sample cell 2-1.

Of course, the cooling unit 6 cools the collector 4-2 to be maintained at a temperature lower than an ambient temperature during the progress of the process.

Meanwhile, a moving rate Vₘ that is a fixing value, not the proportional constant for controlling the rate of the moving plate, may be input to the central controller 7-5. In this case, the central controller 7-5 moves (or rotates) the moving plate at a constant speed according to the moving rate Vₘ of the moving plate, independently of the temperature of the sample cell 2-1.

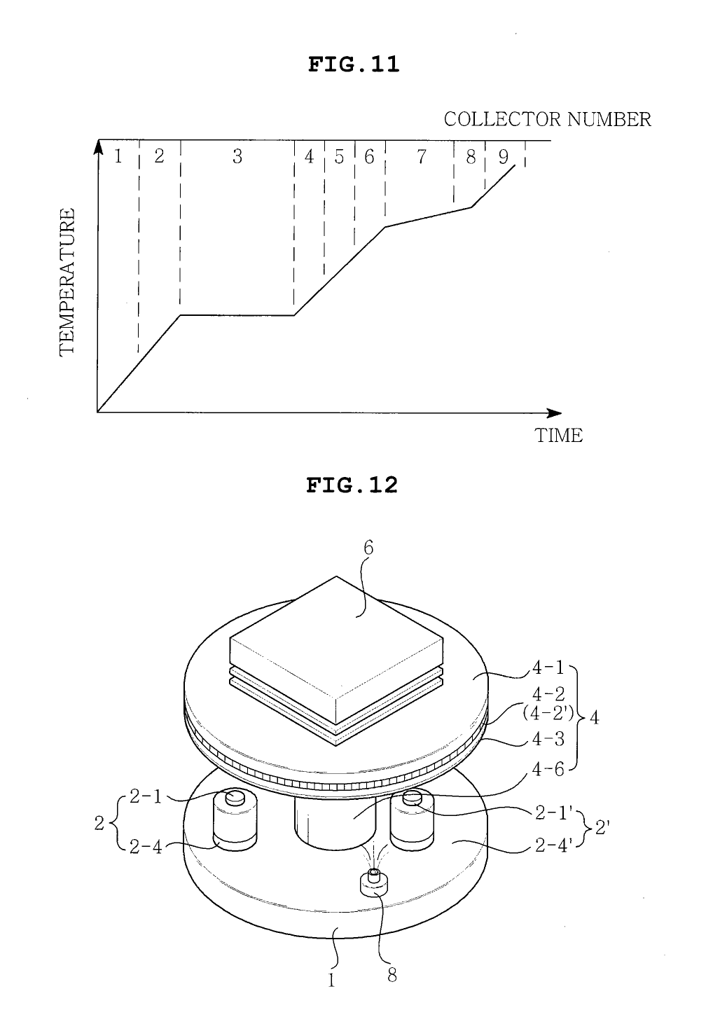

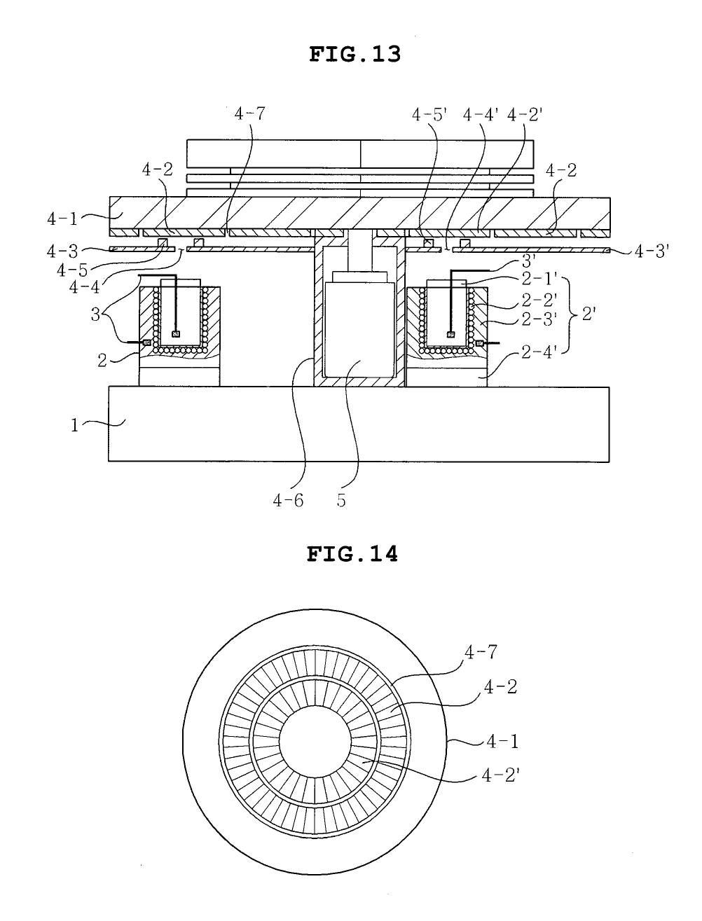

FIG. 12 is a perspective view of an apparatus for separation and condensation of a mixture according to a second preferred embodiment of the present invention, FIG. 13 is a cutaway cross-sectional view of FIG. 12, and FIG. 14 is a plan view of the moving plate of FIG. 12.

The difference between the apparatus for separation and condensation of a mixture according to a second preferred embodiment of the present invention and the apparatus for separation and condensation of a mixture according to the first preferred embodiment is that it includes two sample vaporizing units 2 and 2′, not including one sample vaporizing (as a result, the sample cell is also represented by two reference numerals 2-1 and 2-1′, the heater is also represented by two reference numerals 2-2 and 2-2′, the cell holder is also represented by two reference numerals 2-3 and 2-3′, and the fixing member is also represented by two reference numerals 2-4 and 2-4′).

Of course, the temperature measuring unit is also represented by two reference numerals 3 and 3′. As a result, the collecting unit 4 includes another collector 4-2′ other than one collector 4-2 (as a result, the guiding member is also represented by two reference numerals 4-3 and 4-3′, the opening is also represented by two reference numerals 4-4 and 4-4′, and the spacing member is also represented by two reference numerals 4-5 and 4-5′).

As described above, if the two sample vaporizing units 2 and 2′ are provided and a string of the two collectors 4-2 and 4-2′ are provided accordingly, the material can be collected through the string of the two collectors 4-2 and 4-2′ by one-time driving, thereby making it possible to increase the amount of collected material two times or more.

When other mixtures are stored and vaporized in the sample vaporizing unit 2 and 2′ in some cases, different mixtures can be fractioned and distilled.

In addition, the second preferred embodiment performs the operation under the drying environment to prevent unwanted moisture in the air from being condensed or further includes a purging unit 8 capable of continuously purging the moving plate using dry nitrogen gas to maintain the moving plate at the dried state.

As set forth above, the present invention includes the sample vaporizing unit appropriate for vaporizing a small amount of sample and the collector appropriate for collecting a small amount of sample, thereby making it possible to automatically separate a small amount of mixture.

Although the embodiments of the present invention has been disclosed for illustrative purposes, those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. An apparatus for separation and condensation of a mixture, comprising:
a base part:
a sample vaporizing unit mounted on the base part, storing a sample, and vaporizing the stored sample;
a collecting unit mounted on the base part, including a plurality of collectors formed to be consecutively arranged in a line in order to collect the sample, and allowing the plurality of collectors to sequentially pass through a material vaporized in the sample vaporizing unit;
a driver moving the collecting unit to allow the collectors of the collecting unit to sequentially pass through the sample vaporizing unit; and
a control device controlling the sample vaporizing unit to vaporize the sample and controlling the driver to move the collecting unit.

2. The apparatus for separation and condensation of a mixture as set forth in claim 1, further comprising a cooling unit cooling the collecting unit.

3. The apparatus for separation and condensation of a mixture as set forth in claim 1, further comprising a purging unit keeping the collecting unit at a dried state.

4. The apparatus for separation and condensation of a mixture as set forth in claim 1, further comprising a temperature measuring unit measuring a temperature of the sample vaporizing unit.

5. The apparatus for separation and condensation of a mixture as set forth in claim 1, wherein the control device controls a moving rate of the collecting unit in proportion to variation of temperature of the sample vaporizing unit.

6. The apparatus for separation and condensation of a mixture as set forth in claim 1, wherein the sample vaporizing unit includes:
a sample cell storing the sample;
a heater heating the sample cell; and
a cell holder mounted on the base part and having the sample cell and the heater mounted therein.

7. The apparatus for separation and condensation of a mixture as set forth in claim 1, to wherein the collecting unit includes:
a moving plate including the plurality of collectors formed to be consecutively arranged in a line in order to collect the sample and moving to allow the plurality of collectors to sequentially pass through the material vaporized in the sample vaporizing unit; and
a supporting member supporting the moving plate to be spaced apart from the base part.

8. The apparatus for separation and condensation of a mixture as set forth in claim 7, further comprising a guiding member formed with an opening limiting the vaporized material to be condensed onto only the defined collector.

9. The apparatus for separation and condensation of a mixture as set forth in claim 8, wherein the size of the opening of the guiding member is controlled.

10. The apparatus for separation and condensation of a mixture as set forth in claim 1, wherein the collector has a plate shape.

11. The apparatus for separation and condensation of a mixture as set forth in claim 1, wherein the collector is a solid plate having a micro pattern of an interval of 0.1 to 100 μm.

12. The apparatus for separation and condensation of a mixture as set forth in claim 1, wherein the collector is a capillary array in which capillaries are arranged in a lattice form.

13. The apparatus for separation and condensation of a mixture as set forth in claim 1, wherein the control device includes:
a temperature controller increasing the temperature of the sample vaporizing unit in proportion to the pre-set temperature ramping rate;
a driving controller controlling the driving to move the moving rate of the collecting unit in proportion to the variation of temperature of the sample vaporizing unit; and
a central controller controlling the driver through the driving controller in order to allow the moving rate of the collecting unit to be in proportion to the variation of temperature of the sample vaporizing unit.
